(19) United States
(12) Patent Application Publication
(10) Pub. No.: US 2024/0065436 A1
(43) Pub. Date: Feb. 29, 2024

(54) READY-TO-ASSEMBLE (RTA) METAL CABINET

(71) Applicant: Zhongshan Fulsun Home Improvement Co., Ltd., Zhongshan (CN)

(72) Inventors: Ling ZHU, Zhongshan (CN); Junhao ZENG, Zhongshan (CN)

(73) Assignee: Zhongshan Fulsun Home Improvement Co., Ltd., Zhongshan (CN)

(21) Appl. No.: 17/932,285

(22) Filed: Sep. 14, 2022

(30) Foreign Application Priority Data
Aug. 31, 2022 (CN) 202222327978.1

(51) Int. Cl. A47B 47/00; F16B 12/30

(52) U.S. Cl. CPC A47B 47/0075; F16B 12/30

(57) ABSTRACT

A ready-to-assemble (RTA) metal cabinet includes an upper cabinet board, a lower cabinet board, a left cabinet board, a right cabinet board, a back board and a cabinet door. The upper cabinet board and the lower cabinet board each include a first connecting structure for connecting the left cabinet board and the right cabinet board; a threaded structure is provided in the first connecting structure; the left cabinet board and the right cabinet board are each provided with an installation hole corresponding to the threaded structure, such that a screw is fastened in the threaded structure after running through the installation hole; a second connecting structure used for connecting the cabinet door is further arranged on the left cabinet board and/or the right cabinet board; and the second connecting structure is provided with a relief groove for yielding a position for installation of the screw.

### CROSS-REFERENCE TO RELATED APPLICATIONS

This application claims priority to Chinese Patent Application No. 202222327978.1 with a filing date of Aug. 31, 2022. The content of the aforementioned application, including any intervening amendments thereto, is incorporated herein by reference.

### TECHNICAL FIELD

The present disclosure belongs to the technical field of household products, and particularly relates to a ready-to-assemble (RTA) metal cabinet.

### BACKGROUND

At present, the majority of metal cabinets on the market are pre-assembled, which means no assembly effort is needed by the consumer. However, this assembly mode will lead to increased transportation costs due to the larger size of the product.

Certainly, there are also some metal cabinets that are shipped as unassembled parts, and these parts are supposed to be assembled by consumers. However, these metal cabinets need to be assembled using professional installation tools, such as electric drills and glass cement. Moreover, one cabinet usually has a large number of accessories, making the installation process all the more complicated.

Hence, it is desirable to provide a ready-to-assemble (RTA) metal cabinet.

### SUMMARY

In view of the foregoing technical defect, the present disclosure provides a ready-to-assemble (RTA) metal cabinet, with an aim to achieve the technical effects of reduced transportation cost, simplified installation process, and convenience for a user to install the cabinet independently.

The technical solution of the present disclosure is as follows: a ready-to-assemble (RTA) metal cabinet is provided, including an upper cabinet board, a lower cabinet board, a left cabinet board, a right cabinet board, a back board and a cabinet door, where the upper cabinet board and the lower cabinet board each include a first connecting structure for connecting the left cabinet board and the right cabinet board; a threaded structure is provided in the first connecting structure; the left cabinet board and the right cabinet board are each provided with an installation hole corresponding to the threaded structure, such that a screw is fastened in the threaded structure after running through the installation hole; a second connecting structure used for connecting the cabinet door is further arranged on the left cabinet board and/or the right cabinet board; and the second connecting structure is provided with a relief groove for yielding a position for installation of the screw.

Preferably, the first connecting structure is a cylindrical groove having two ends provided with an internal thread structure.

Preferably, the left cabinet board and the right cabinet board each include a side plate and the second connecting structure, the second connecting structure is arranged on one side edge of the side plate and has a first bending part facing the other side edge of the side plate, and the relief groove is formed on the first bending part.

Preferably, the left cabinet board and the right cabinet board each further include a third connecting structure for connecting the back board, and the second connecting structure and the third connecting structure are arranged on the two side edges of the side plate, respectively.

Preferably, the third connecting structure has a second bending part which is arranged in a direction away from the first bending part.

Preferably, the back board is provided with a wrapping edge.

Preferably, a press-in nut for screwed connection with the cabinet door is arranged on the second connecting structure.

Preferably, a press-in nut for screwed connection with the back board is arranged on the third connecting structure.

The embodiment of the present disclosure has the following beneficial effects: the upper cabinet board and the lower cabinet board are each provided with a connecting structure, and pre-tapping processing is carried out, such that a user can easily assemble the cabinet simply with a common screwdriver. Moreover, the structure may also avoid the process of connecting cabinet boards by installing angle brackets, which thus simplifies the installation process. As the user can complete assembly on his/her own, the packaging size of the product can be greatly reduced, which thus saves the transportation cost.

### BRIEF DESCRIPTION OF THE DRAWINGS

To describe the technical solutions in the embodiment of the present disclosure or in the prior art more clearly, the following briefly introduces the accompanying drawings required for describing the embodiment or the prior art. Apparently, the accompanying drawings in the following description show merely embodiments of the present disclosure, and a person of ordinary skill in the art may still derive other drawings from these accompanying drawings without creative efforts.

FIG. 1 is a structural diagram of a metal cabinet according to an embodiment of the present disclosure;

FIG. 2 is a partial structural diagram of an upper cabinet board according to the present disclosure;

FIG. 3 is a partial structural diagram of an upper cabinet board and a right cabinet board according to the present disclosure;

FIG. 4 is a structural diagram of a back board according to the present disclosure;

FIG. 5 is a structural diagram of a left cabinet board according to the present disclosure;

FIG. 6 is a partial structural diagram of a right cabinet board according to the present disclosure; and

FIG. 7 is a structural diagram of a cabinet door according to the present disclosure.

Reference Numerals: 10. metal cabinet, 110. upper cabinet board, 111. first connecting structure, 112. threaded structure, 120. right cabinet board, 121. installation hole, 122. second connecting structure, 1221. first bending part, 123. relief groove, 124. side plate, 1241. side edge, 1242. side edge, 125. third connecting structure, 1251. second bending part, 130. lower cabinet board, 140. left cabinet board, 141. press-in nut, 150. back board, 151. wrapping edge, 152. installation hole, 160. cabinet door, 161. hinge, and 170. screw.

### DETAILED DESCRIPTION OF THE EMBODIMENTS

In order to explain the examples of the present disclosure or the technical solutions in the prior art more clearly, the specific implementations of the present disclosure will be described below with reference to the accompanying drawings. Apparently, the accompanying drawings in the following description show merely some examples of the present disclosure, and other drawings and other implementations may be derived from these drawings by a person of ordinary skill in the art without creative efforts.

For the brevity of the drawings, only the parts related to the present disclosure are schematically shown in each figure, which do not represent the actual structure of the product. In addition, in order to make the drawings concise and easy to understand, only one of the components with the same structure or function is graphically shown or marked in some figures. Herein, the term “one” may indicate not only “only this one”, but also “more than one”.

The technical solution of the present disclosure will be described in detail below with reference to specific embodiments.

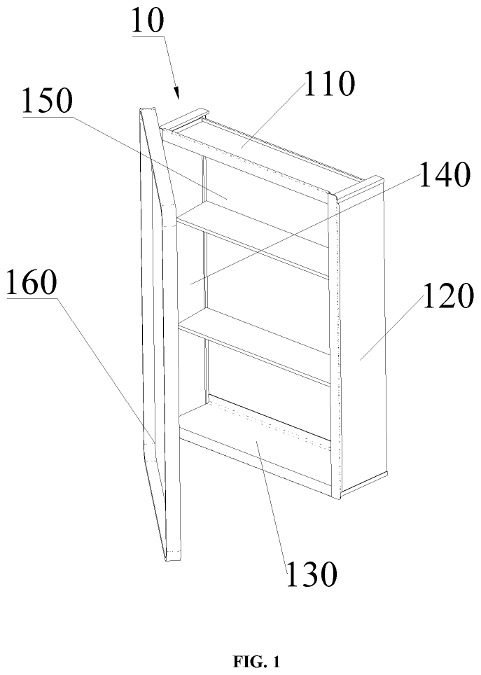

As shown in FIG. 1, the present disclosure provides a ready-to-assemble (RTA) metal cabinet 10 including an upper cabinet board 110, a lower cabinet board 130, a left cabinet board 140, a right cabinet board 120, a back board 150 and a cabinet door 160. The metal cabinet 10 may be an aluminum alloy cabinet or a cabinet combined by aluminum alloy and a mirror. Certainly, the metal cabinet 10 may be made of other metal materials, such as stainless steel, iron and copper. Herein, the involved orientation terms such as “upper”, “lower”, “left” and “right” are defined in terms of positions of the cabinet after assembly, and the observer view the cabinet directly in front of the cabinet door. It should be understood that apart from the foregoing structures, the metal cabinet 10 may be internally provided detachable laminates, such that the space of the cabinet can be further freed up.

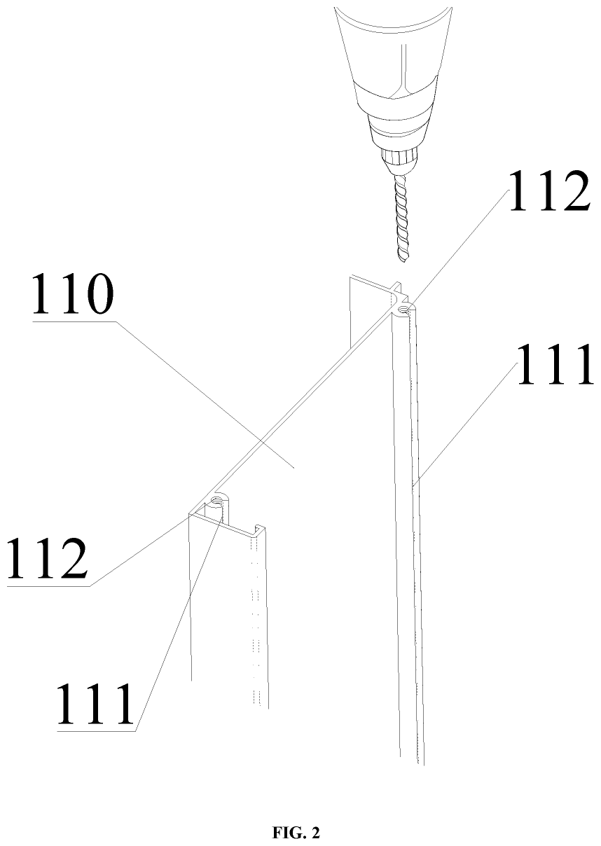

As shown in FIG. 1 and FIG. 2, both the upper cabinet board 110 and the lower cabinet board 130 include a first connecting structure 111 for connecting the left cabinet board 140 and the right cabinet board 120. In the actual manufacturing process, in order to simplify the processing technology, the structures of the upper cabinet board 110 and the lower cabinet board 130 are usually mirror symmetrical, so do the structures of the left cabinet board 140 and the right cabinet board 120. Therefore, the mirror structure is not repeated in the drawings. The first connecting structure 111 is internally provided with a threaded structure 112. The threaded structure 112 can be pre-processed by a tapping machine (not shown) before delivery. In both the upper cabinet board 110 and the lower cabinet board 130, there are usually two first connecting structures 111 arranged on both sides of the cabinet board, thereby ensuring the stability of the connection. In both the upper cabinet board 110 and the lower cabinet board 130, the first connecting structures 111 and the cabinet board are integrally formed. In another embodiment of the present disclosure, the first connecting structures 111 may be welded to the cabinet board.

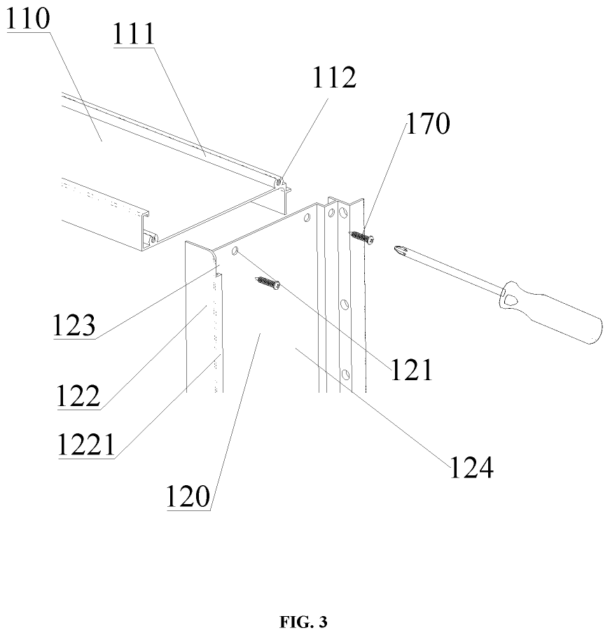

As shown in FIG. 3, the left cabinet board 140 and the right cabinet board 120 are each provided with an installation hole 121 corresponding to the threaded structure 112, such that a screw 170 is fastened in the threaded structure 112 after running through the installation hole 121. Through the pre-tapping processing, the connection and installation between the cabinet boards can be completed by an ordinary screwdriver (not shown) without the need for any professional installation tool, such as electric drills, or glass cement. A second connecting structure 122 used for connecting the cabinet door 160 is further arranged on the left cabinet board 140 and/or the right cabinet board 120. As shown in FIG. 3, the second connecting structure 122 is provided with a relief groove 123 for yielding a position for installation of the screw 170. In one embodiment of the present disclosure, the second connecting structure 122 and the cabinet boards are integrally formed.

Further, as shown in FIG. 2 and FIG. 3, the first connecting structure 111 is a cylindrical groove having two ends provided with an internal thread structure 112. On the one hand, the cylindrical groove can easily be provided with the internal thread structure; on the other hand, the cylindrical groove can also be used as a cabinet fixation structure, that is, a connector can be inserted into the installation groove to secure the cabinet on the wall body, thereby enhancing the stability of the cabinet.

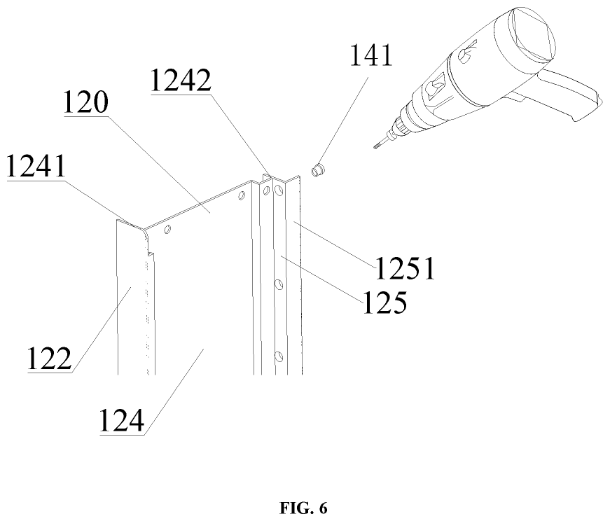

Further, as shown in FIG. 3 and FIG. 6, both the left cabinet board 140 band the right cabinet board 120 include a side plate 124 and the second connecting structure 122. The second connecting structure 122 is arranged on one side edge 1241 of the side plate 124, and the second connecting structure 122 has a first bending part 1221 facing the other side edge 1242 of the side plate 124, and the relief groove 123 is formed on the first bending part 1221. In the prior art, the upper cabinet board 110 and the right cabinet board 120 are connected through an angle bracket, where the angle bracket may one end inserted into a bending part of the upper cabinet board 110, and the other end inserted into a bending part of the right cabinet board 120. In this connection mode, the number of parts and components may be increased, and the installation process is more complex, given that the user needs to put an angle bracket into the upper cabinet board first, and then put an angle bracket into the right cabinet board. The improved structure allows the upper cabinet board and the right cabinet board to be secured together directly through screws. The arrangement of the first bending part 1221 can avoid the potential harm of sharp edges and angles in the metal cabinet to users, especially children. However, the presence of the bending part may hinder the installation of the screw. Therefore, a relief groove 123 is formed on the first bending part 1221 to facilitate the installation of the screw.

Further, as shown in FIG. 3 and FIG. 6, both the left cabinet board 140 and the right cabinet board 120 further include a third connecting structure 125 for connecting the back board 150, and the second connecting structure 122 and the third connecting structure 125 are arranged on the side edges 1241 and side edge 1242 of the side plate 124, respectively. In embodiments of the present disclosure, the second connecting structure, the side plate 124 and the third connecting structure 125 are integrally formed.

Further, as shown in FIG. 6, the third connecting structure 125 has a second bending part 1251 which is arranged in a direction away from first bending part 1221. The orientation of the second bending part neither causes harm to the user nor hinders the installation of screws.

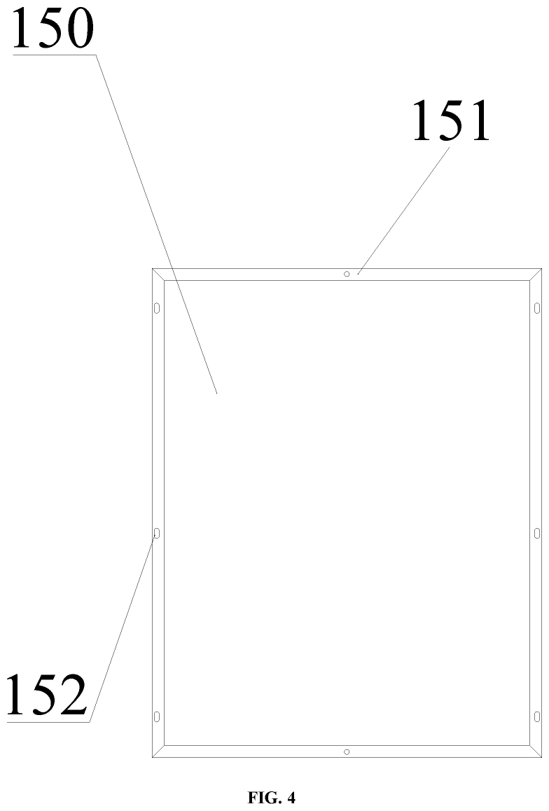

Further, as shown in FIG. 4, the back board 150 is provided with a wrapping edge 151. The edges around the back board are provided with an installation hole 152, and the installation hole 152 can be formed on the wrapping edge 151 arranged, so that the installation hole is less likely to get broken. In addition, if the back board is a mirror made of glass, the arrangement of the wrapping edge 151 can avoid opening in the glass and facilitate the user to perform installation directly with screws.

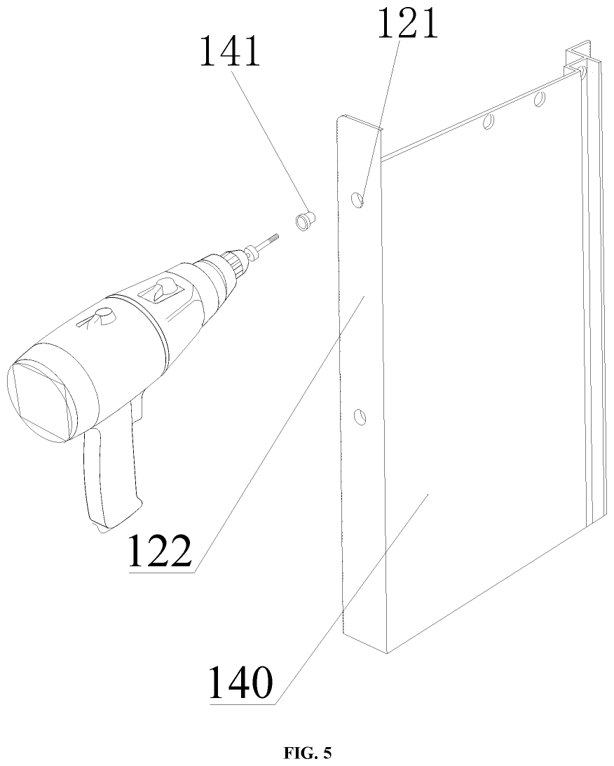

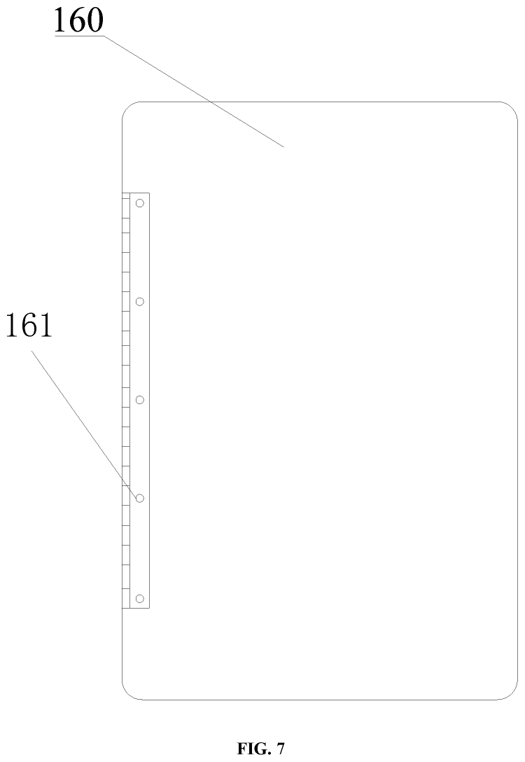

Further, as shown in FIG. 5, the cabinet door 160 is secured on the left cabinet board 140 according to personal habits of the user. The second connecting structure 122 is provided with an installation hole 121 which is internally provided with a press-in nut 141 for screwed connection with the cabinet door 160. As shown in FIG. 7, the cabinet door 160 is provided with a hinge 161, an installation hole on the hinge 161 corresponds to the press-in nut 141, and the screw 170 may run through the installation hole on the hinge 161 to be fixed in the press-in nut 141.

Further, as shown in FIG. 6, a press-in nut 141 for screwed connection with back board 150 is arranged on the third connecting structure 125. As shown in FIG. 5 and FIG. 6, the press-in nut 141 can be driven into the installation hole of the cabinet board through an electric drill (not shown) before delivery, and the user then may complete the connection and installation of the cabinet simply with an ordinary screwdriver.

Although some preferred examples of the present disclosure have been described, a person skilled in the art can make changes and modifications to these examples once they learn the basic inventive concept. Therefore, the appended claims are intended to be interpreted as including the preferred embodiments and all changes and modifications falling within the scope of the present disclosure.

Apparently, a person skilled in the art can make various changes and modifications to the present disclosure without departing from the spirit and scope of the present disclosure. The present disclosure is intended to cover these modifications and variations provided that they fall within the scope of protection defined by the claims of the present disclosure and equivalents thereof.

What is claimed is:

1. A ready-to-assemble (RTA) metal cabinet, comprising an upper cabinet board, a lower cabinet board, a left cabinet board, a right cabinet board, a back board and a cabinet door, wherein the upper cabinet board and the lower cabinet board each comprise a first connecting structure for connecting the left cabinet board and the right cabinet board; a threaded structure is provided in the first connecting structure; the left cabinet board and the right cabinet board are each provided with an installation hole corresponding to the threaded structure, such that a screw is fastened in the threaded structure after running through the installation hole; a second connecting structure used for connecting the cabinet door is further arranged on the left cabinet board and/or the right cabinet board; and the second connecting structure is provided with a relief groove for yielding a position for installation of the screw.

2. The RTA metal cabinet according to claim 1, wherein the first connecting structure is a cylindrical groove having two ends provided with an internal thread structure.

3. The RTA metal cabinet according to claim 1, wherein the left cabinet board and the right cabinet board each comprise a side plate and the second connecting structure, the second connecting structure is arranged on one side edge of the side plate and has a first bending part facing the other side edge of the side plate, and the relief groove is formed on the first bending part.

4. The RTA metal cabinet according to claim 3, wherein the left cabinet board and the right cabinet board each further comprise a third connecting structure for connecting the back board, and the second connecting structure and the third connecting structure are arranged on the two side edges of the side plate, respectively.

5. The RTA metal cabinet according to claim 4, wherein the third connecting structure has a second bending part which is arranged in a direction away from the first bending part.

6. The RTA metal cabinet according to claim 1, wherein the back board is provided with a wrapping edge.

7. The RTA metal cabinet according to claim 1, wherein a press-in nut for screwed connection with the cabinet door is arranged on the second connecting structure.

8. The RTA metal cabinet according to claim 4, wherein a press-in nut for screwed connection with the back board is arranged on the third connecting structure.
